(19) United States
(12) Patent Application Publication
(10) Pub. No.: US 2020/0236180 A1
(43) Pub. Date: Jul. 23, 2020

(54) APPARATUS AND METHOD FOR COMMUNICATION, AND STORAGE MEDIUM

(71) Applicant: CANON KABUSHIKI KAISHA, Tokyo (JP)

(72) Inventor: Yuki Yoshikawa, Yokohama-shi (JP)

(21) Appl. No.: 16/840,221

(22) Filed: Apr. 3, 2020

Related U.S. Application Data
(63) Continuation of application No. PCT/JP2018/035639, filed on Sep. 26, 2018.

(30) Foreign Application Priority Data
Oct. 13, 2017 (JP) 2017-199630

(51) Int. Cl. H04L 29/08; H04W 8/00; H04W 88/08

(52) U.S. Cl. CPC H04L 67/16; H04L 67/28; H04W 88/08; H04W 8/005

(57) ABSTRACT

A communication apparatus transmits and receives a radio signal in a period of a predetermined length that comes at predetermined time intervals to perform a proxy process of at least transmission and reception of the radio signal in the period as a proxy of a specific communication apparatus belonging to a group of a plurality of communication apparatuses synchronizing in the period. The communication apparatus stores at least one of the result of the proxy process, the proxy process to be performed, and the number of operations of the proxy process. When it is determined that the details have changed, the communication apparatus provides a notification to the specific communication apparatus.

### CROSS-REFERENCE TO RELATED APPLICATIONS

This application is a Continuation of International Patent Application No. PCT/JP2018/035639, filed Sep. 26, 2018, which claims the benefit of Japanese Patent Application No. 2017-199630, filed Oct. 13, 2017, both of which are hereby incorporated by reference herein in their entirety.

### TECHNICAL FIELD

The present invention relates to a communication technique.

### BACKGROUND ART

In recent years, wireless local area networks (LANs) typified by the IEEE802.11 series have been widely used. In most cases, the wireless LAN is controlled by a base station called an access point (AP). The AP and stations (STAs) in a wireless connection status within the radio wave coverage of the AP constitute the wireless network.

Not only such a simple, conventional wireless network configuration constituted by an AP and STAs, products and specification standards of various wireless LAN networks have come on the market. PTL 1 discloses a neighbor awareness networking (NAN) standard defined by Wi-Fi Alliance as a standard for discovering a communication apparatus and a service provided by the communication apparatus with lower power consumption. This achieves power saving by synchronizing a period during which the communication apparatus exchanges information with another communication apparatus with the other communication apparatus to reduce the time during which a radio frequency (RF) unit is enabled. The period for synchronization of the NAN is called Discovery Window (DW). A group of NAN devices that share a predetermined synchronization period is called “NAN cluster”. Among the NAN devices, terminals serving as Master and Non-Master Sync transmit Sync beacons, which are signals for synchronization between the terminals during the DW period. The NAN devices establish synchronization with other terminals and transmit and receive, for example, a Subscribe massage, which is a signal for discovering a service, and a Publish message, which is a signal for reporting provision of the service during the DW period. The NAN devices can also transmit and receive Follow-up message for exchange additional information on the service during the DW period. In contrast, the NAN devices can enter a DOZE state in which no radio signal is received during some DW period, further reducing power consumption.

The frequency of DW periods in which radio signals are received depends on the NAN device. However, all NAN devices participating in the NAN cluster need to be in a state of being capable of receiving radio signals without fail during a particular DW period called DW0 (hereinafter referred to as “awake mode”). DW0 is a DW period that comes every 16 DW periods. DW0 starts from the time at which lower 23 bits of a time synchronization function (TSF), which is a counter timer that the NAN cluster uses for synchronization, is 0 x 0. Since the NAN devices acting as Master and Non-Master Sync need to transmit Sync beacons every DW period, the NAN devices can receive radio signals all the DW periods.

In contrast, NAN devices that do not transmit Sync beacons every DW period act as Non-Master Non-Sync and do not need to be in the awake mode in all the DW periods, and it is sufficient that the NAN devices are in the awake mode at least during DW0.

A method for discovering the service of a second communication apparatus in a range in which the radio signal of a first communication apparatus by requesting a service search and provision from a third communication apparatus (PTL 2). This allows, for example, a communication apparatus that requests proxy (hereinafter referred to as “Proxy client”) to request a communication apparatus that is requested to act as proxy (hereinafter referred to as “Proxy server”) to transmit a Subscribe message by proxy. The Proxy server that has received the request transmits the Subscribe message in place of the Proxy client and notifies the Proxy client of the result.

Thus, using the NAN allows efficient service discovery. However, if the Proxy server executes notification of the result of proxy processing every DW period, the processing load of the Proxy server and communication amount are increased to increase power consumption.

Accordingly, there is a need in the art to reduce the communication amount and power consumption of an apparatus that execute proxy processing.

### CITATION LIST

### Patent Literature

PTL 1 US Patent Application Publication No. 2014/0302787

PTL 2 US Patent Application Publication No. 2015/0081840

### SUMMARY OF INVENTION

A communication apparatus according to an aspect of the present invention includes a communication unit configured to transmit and receive a radio signal in a period of a predetermined length that comes at predetermined time intervals, a processing unit configured to perform a proxy process of at least transmission and reception of the radio signal in the period as a proxy of a specific communication apparatus belonging to a group of a plurality of communication apparatuses synchronizing in the period, a storage unit configured to store at least one of a result of the proxy process performed by the processing unit, the proxy process to be performed by the processing unit, and a number of operations of the proxy process, a determination unit configured to determine whether details stored by the storage unit have changed, and a notification unit configured, when the determination unit determines that the details have changed, to provide a notification based on the details stored in the storage unit to the specific communication apparatus.

Further features of the present invention will become apparent from the following description of exemplary embodiments with reference to the attached drawings.

### BRIEF DESCRIPTION OF DRAWINGS

FIG. 1 is a diagram illustrating the configuration of a communication system.

FIG. 2 is a block diagram illustrating the functional configuration of a NAN device 101.

FIG. 3 is a block diagram illustrating the hardware configuration of the NAN device 101.

FIG. 4 is a flowchart illustrating the operation of the NAN device 101 according to a first embodiment.

FIG. 5 is a diagram illustrating the configuration of a frame used in the first embodiment.

FIG. 6 is a diagram illustrating the sequence of the communication system of the first embodiment.

FIG. 7 is a flowchart illustrating the operation of the NAN device 101 according to a second embodiment.

FIG. 8 is a diagram illustrating the configuration of a frame used in the second embodiment.

FIG. 9 is a diagram illustrating the sequence of the communication system of the second embodiment.

### DESCRIPTION OF EMBODIMENTS

Embodiments of the present invention will be described hereinbelow with reference to the drawings. In the following description, although the communication apparatuses are terminals having a wireless LAN communication function based on the IEEE802.11 standard series, this is given for illustrative purpose only. Although the communication apparatuses can discover other communication apparatuses and the services provided by the communication apparatuses on the basis of the Wi-Fi neighbor awareness networking (NAN) standard, this is given for illustrative purpose only. Although the following descriptions use technical terms of a given standard, the following descriptions may be applied to other standards of the same type.

The NAN will be described. In the NAN, service information is communicated in a period called Discovery Window (hereinafter referred to as “DW”). The DW is a period and a channel in which a plurality of devices that execute the NAN converge. A group of terminals that share the schedule of the DW is referred to as “NAN cluster”.

The individual terminals that belong to the NAN cluster act as any one of Master, Non-Master Sync, and Non-Master Non-Sync. A terminal that acts as Master transmits a synchronization beacon (hereinafter referred to as “Sync beacon”) for each device to identify the DW and to synchronize with each other. A device that acts as Master transmits Discovery beacons, which are signals for making terminals that do not belong to the NAN cluster recognize the NAN cluster. The Discovery beacon is transmitted every 100 time units (TU, 1 TU=1,024 μs) outside the period of DW. In each NAN cluster, at least one terminal acts as Master.

A terminal acting as Non-Master Sync transmits Sync beacons but does not transmit Discovery beacons. A terminal acting as Non-Master Non-Sync transmits neither of the Sync beacon and the Discovery beacon.

The terminals participating in the NAN cluster synchronize with each other in the DW periods of a predetermined cycle in response to the Sync beacons and communicate service information in the DW periods.

The terminals communicate a Subscribe message, which is a signal for discovering a service and a Publish message, which is a signal for reporting provision of the service, with each other in the DW periods. Furthermore, the terminals can send and receive a Follow-up message for exchanging additional information on the service in the DW periods. The Subscribe, Publish, and Follow-up messages are collectively referred to as “Service Discovery frame (SDF)”. The terminals can publicize or detect the service by exchanging the SDF. An NAN device that transmits a Subscribe message is referred to as “Subscriber”. An NAN device that transmits a Publish message is referred to as “Publisher”.

As described above, the NAN device goes to the DOZE mode in which no radio signal is transmitted and received also in the DW periods to reduce power consumption. Meanwhile, such an NAN device cannot transmit and receive a Subscribe message and a Publish message in the DW periods in which the NAN devices are in the DOZE mode. This may increase the period until a service provided by the NAN device is discovered by another NAN device.

In contrast, some NAN device can request service search and notification, such as Subscribe and Publish, from another NAN device. In the present embodiment, a specific NAN device that executes service search and notification of another NAN device by proxy is referred to as “proxy server”, and a specific NAN device that requests proxy processing from another NAN device is referred to as “proxy client”. When a Proxy server is requested from a Proxy client to transmit service information by proxy, the Proxy server transmits the service information of the Proxy client by proxy. Since the Proxy Server executes service search and/or notification in place of the Proxy client, the Proxy client can stay in the DOZE mode for a long time, thereby remarkably reducing power consumption. Furthermore, when an NAN device that searches for a service provided by Proxy client sends a Subscribe message, Proxy server may send a response while Proxy client is in sleep mode. This increases the possibility that the NAN device that searches for a service can discover the service provided by Proxy client even if Proxy client is in sleep mode because Proxy server sends a response in place of Proxy client.

However, if the Proxy server that is requested from the Proxy client to execute proxy processing for service search and notification frequently enters the DOZE mode, the period of proxy processing for service search and notification for the Proxy client is decreased. For that reason, making the Proxy server enter the awake mode in as many DWs as possible eliminates such a problem. Meanwhile, a Proxy server that has not received a Proxy request needs not be in the awake mode in many DWs and preferably be in the DOZE mode in reducing the power consumption.

The configurations of a wireless communication system and a communication apparatus common among the embodiments will be described, and then the processing procedures of the embodiments will be described.

Configuration of Wireless Communication System

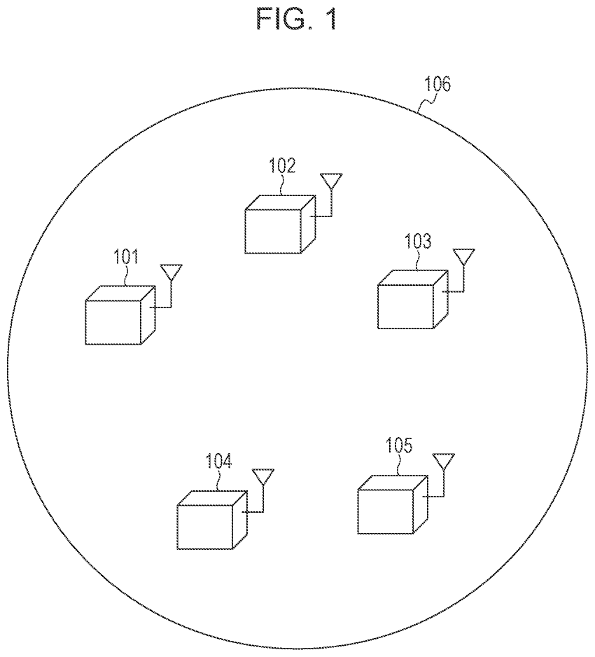

First, a configuration example of a wireless communication system of the present embodiment will be described with reference to FIG. 1. The wireless communication system of the present embodiment includes NAN devices 101 to 105, which are communication apparatuses based on the NAN standard. The NAN devices 101 to 105 participate in a NAN cluster 106. The NAN devices (NAN devices 101 to 105) participating in the NAN cluster 106 configure a network on ch. 6 (2.437 GHz) in a 2.4 GHz frequency band. The NAN cluster 106 is a NAN cluster whose DW period has 16 time units (TUs) and in which the time interval between the DW period start timing to the next DW start timing is 512 TUs. The DW period includes 16 DW periods from DW0 to DW15. A DW period after the 16 DWn (n is an integer from 0 to 15) is also DWn. All the NAN devices participating in the NAN cluster 106 are in the awake mode during DW0, so that the NAN devices can receive radio signals.

The NAN device 101 is a communication apparatus capable of executing the following processes. The NAN device 101 can discover neighboring communication apparatuses and services provided by the neighboring communication apparatuses and provide information on services that the NAN device 101 can provide on the basis of the NAN standard. The NAN device 101 can act as a Proxy server capable of executing searching for a service and a notification thereof as a proxy for another NAN device. The NAN device 101 participates in the NAN cluster 106 as Master.

The NAN devices 102 and 105 are communication apparatuses participating in the NAN cluster 106 as Non-Master Non-Sync. The NAN device 102 searches for a print service and a chat service. The NAN device 105 searches for a photo-sharing service. The NAN devices 102 and 105 have the function of a Proxy client and, when discovering a Proxy server, the NAN devices 102 and 105 can request service search by proxy. If the NAN devices 102 and 105 are performing service search by themselves, that is, do not request Proxy, the NAN devices 102 and 105 receive radio signals in all the DW periods. In contrast, if the NAN devices 102 and 105 request Proxy, the NAN devices 102 and 105 receive radio signals only in DW0, DW2, and DW4.

The NAN devices 103 and 104 are Publishers capable of providing a print service that the NAN device 102 searches for. The NAN device 103 performs notification of the service in DW1 and DW3 in the NAN cluster 106.

The NAN devices 101 to 105 enter the DOZE mode in which no electric power is supplied to the communication unit during a DW period in which no radio signal is transmitted and received.

Each of the NAN devices 101 to 105 may play another role. For example, the NAN device 102 may act as Publisher that transmits a Publish message, which is a service provision signal for providing a service. A mode in which radio waves can be transmitted and received is referred to as “awake mode”, and a mode in which no radio wave can be transmitted and received is referred to as “sleep mode”. A proxy search service registered in the Proxy server is referred to as “proxy service”.

Configuration of NAN Device 101

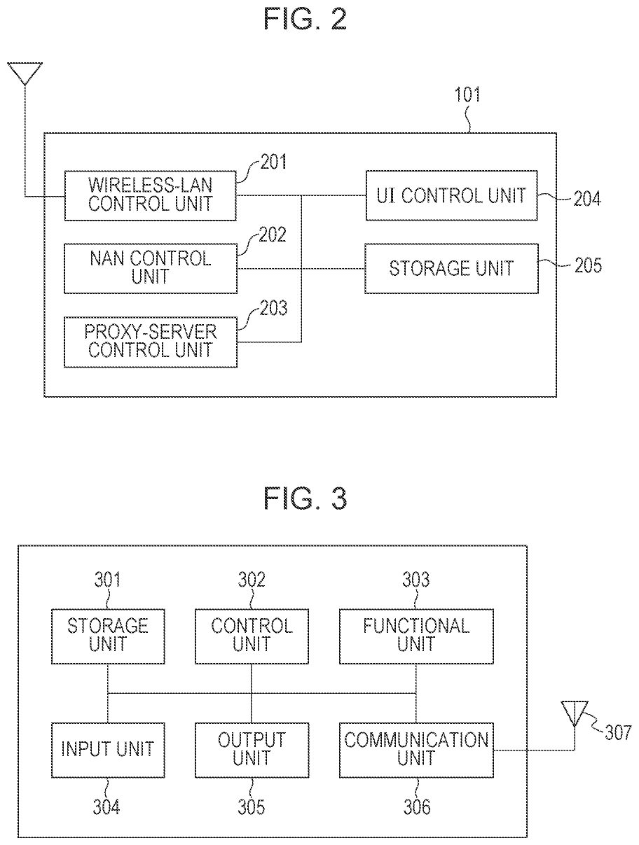

FIG. 2 is a block diagram illustrating an example functional configuration of the NAN device 101. The NAN device 101 includes, as its functional configuration, a wireless-LAN control unit 201, NAN control unit 202, a Proxy-server control unit 203, a user-interface (UI) control unit 204, and a storage unit 205.

The wireless-LAN control unit 201 includes an antenna and a circuit for transmitting and receiving radio signals to and from other wireless LAN devices and a program for controlling them. The wireless-LAN control unit 201 executes wireless LAN communication control based on the IEEE802.11 standard series. The NAN control unit 202 includes programs and hardware for executing control based on the NAN standard. The Proxy-server control unit 203 controls the NAN control unit 202 to implement a Proxy function for a proxy search and notification of the services of other NAN devices. The UI control unit 204 includes hardware related to user interfaces (not illustrated) for receiving a user operation on the NAN device 101, such as a touch panel and a button, and programs for controlling the hardware. The UI control unit 204 also has a function for presenting information to the user, for example, displaying images or audio output. The storage unit 205 is a storage device, such as a read-only memory (ROM) or a random-access memory (RAM), that stores programs for the NAN device 101 and data.

FIG. 3 illustrates the hardware configuration of the NAN device 101 according to the present embodiment. An example hardware configuration of the NAN device 101 includes a storage unit 301, a control unit 302, a functional unit 303, an input unit 304, an output unit 305, a communication unit 306, and an antenna 307.

The storage unit 301 includes one or more ROMs and/or RAMS and stores programs for the following various operations and various pieces of information including communication parameters for wireless communication. Examples of the storage unit 301 other than the ROM and RAM include a flexible disk, a hard disk, an optical disk, a magnetooptical disk, a compact disc read-only memory (CD-ROM), a compact disc recordable (CD-R), magnetic tape, a non-volatile memory card, a digital versatile disc (DVD), and other storage media.

The control unit 302 includes one or more processors, such as a central processing unit (CPU) or a micro-processing unit (MPU), and controls the entire NAN device 101 by executing the programs stored in the storage unit 301. The control unit 302 may control the entire NAN device 101 in cooperation with the programs stored in the storage unit 301 and an operating system (OS).

The control unit 302 controls the functional unit 303 to execute predetermined processing, such as image capturing, printing, and projection. The functional unit 303 is hardware for the NAN device 101 to execute predetermined processing. If the NAN device 101 is a camera, the functional unit 303 serves as an image capturing unit for executing image capturing. If the NAN device 101 is a printer, the functional unit 303 serves as a printing unit for executing printing. If the NAN device 101 is a projector, the functional unit 303 serves as a projection unit for executing projection. The data that the functional unit 303 processes may be data stored in the storage unit 301 or data obtained by communicating with another communication apparatus via the communication unit 306 described later.

The input unit 304 receives various operations from the user. The output unit 305 produces various outputs to the user. The outputs produced by the output unit 305 include at least one of a display on a screen, an audio output using a speaker, and a vibration output. Both of the input unit 304 and the output unit 305 may be implemented by one module, such as a touch panel.

The communication unit 306 controls wireless communication based on the IEEE802.11 standard series or Internet protocol (IP) communication. The communication unit 306 controls the antenna 307 to transmit and receive radio signals for wireless communication. The NAN device 101 communicates image data, document data, video data, and other various contents with other communication apparatuses via the communication unit 306.

Embodiments of the processing procedure of the NAN device 101 and the sequence of the wireless communication system will be described hereinbelow.

### First Embodiment

In the present embodiment, the NAN device 101 searches for a service as a proxy of the NAN device 102 and, when the search result has changed, the NAN device 101 notifies the NAN device 102 of the search result.

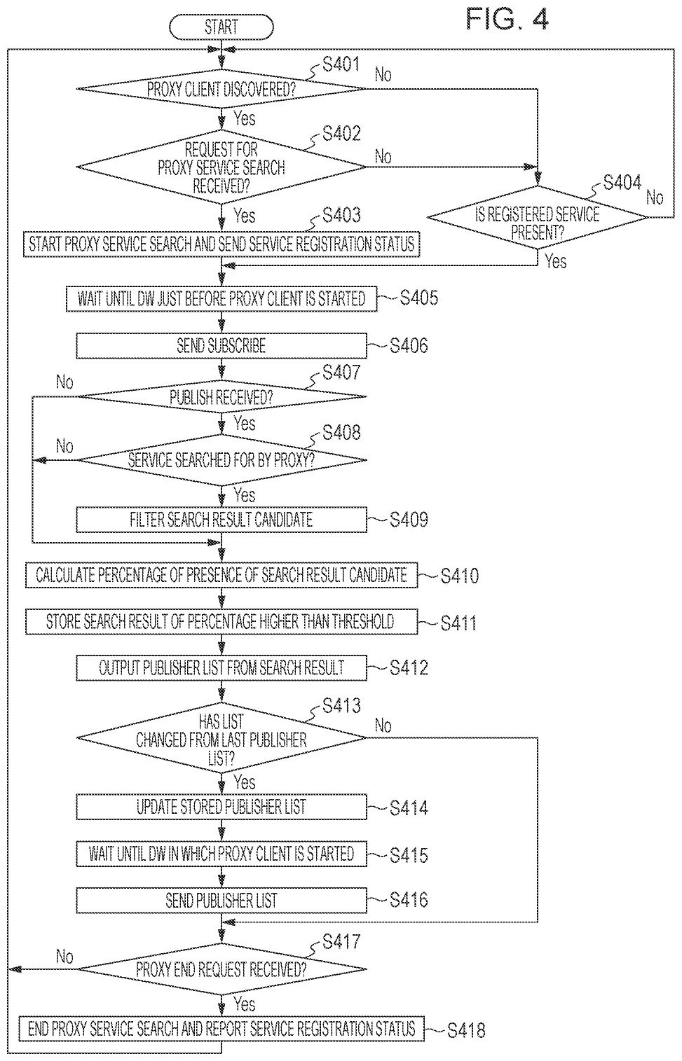

The operation of the NAN device 101 that performs a service search in the NAN cluster 106 as a proxy for the NAN device 102 will be described with reference to the flowchart of FIG. 4. The flowchart is started when the NAN device 101 participates in the NAN cluster 106 and starts the operation as a Proxy server. The flowchart of FIG. 4 is executed by the control unit 302 of the NAN device 101 executing a control program stored in the storage unit 301 to execute computation and processing of information and control of each hardware component. Part or all of the steps of the flowchart in FIG. 4 may be implemented by hardware, such as an application-specific integrated circuit (ASIC).

Upon starting the operation as the Proxy server, the NAN device 101 notifies the surroundings that the NAN device 101 can act as Proxy server. Specifically, the NAN device 101 may send a Publish message including information on the Proxy service, which is the service to be provided, or a Sync beacon including information indicating that the NAN device 101 can act as Proxy server. Alternatively, the NAN device 101 may start to act as Proxy server after receiving information indicating that another NAN device acts as Proxy client.

The NAN device 101 determines whether a Proxy client has been discovered (S401). If a Proxy client has been discovered, the NAN device 101 determines whether a proxy service search request has been received from the Proxy client (S402). If a proxy search request has been received, the NAN device 101 registers the details of the request as a service registration and starts proxy service search (S403). Furthermore, the NAN device 101 transmits a service registration status to the Proxy client, which is the requestor of the proxy search (S403).

The service registration status is the status of service registration including the kind of the proxy service registered in the NAN device 101 serving as Proxy server, the number of proxy processes registered, and information indicating the Proxy client that requests proxy processing. Although a Proxy server executes proxy processing in response to a request from a Proxy client, the number of registrations is limited. For example, when the number of registrations reaches 10, the following (eleventh) proxy processing cannot be registered. For that reason, the Proxy server stores the number of proxy processes registered, the kind of service for proxy processing, and information on the requestor of the registration for management. The kind of service for proxy processing includes information indicating the details of the service, such as a print service, a chat service, or an image transmission service, in addition to information indicating the kind of proxy processing, such as search (Subscribe) and Publish. The information indicating the details of the service is managed as, for example, a hash value of the service name. The information indicating the Proxy client may be any information identifying the device, such as the device ID, a media access control (MAC) address, and the universally unique identifier (UUID) of the Proxy client. At S403, the NAN device 101 transmits the information to the NAN device 102. The NAN device 102 that has received the information can determine how many proxy processes the NAN device 102 can request from the NAN device 101 serving as Proxy server.

In the present embodiment, the NAN device 101 receives a request for registration of a proxy search for a print service from the NAN device 102 serving as Subscriber. The registration operation of proxy processing from S401 to S403 and the processing of the proxy search, described below, may be executed in parallel. The NAN device 101 may register a plurality of services requested from a plurality of Proxy clients. Therefore, even if a service registration request is not received at a certain timing (No at S401 or S402), the NAN device 101 determines whether a registered service is present (S404), and if Yes, the NAN device 101 starts a proxy search as Proxy server.

The operation of the NAN device 101 at the start of the proxy search will be specifically described. The NAN device 101 waits until DW immediately before the Proxy client is started with reference to the service registration (S405). The above-described service registration includes information indicating DW in which the Proxy client is active together with identification information on the Proxy client. This information is transmitted from the Proxy client when the Proxy client requests service registration. The NAN device 101 transmits a service search frame of the service that is searched for by proxy (S406). In place of the processing of S405, the NAN device 101 may transmit the service search frame not only in the DW immediately before the Proxy client becomes active but also, for example, in all the DWs. However, the searching only in the DW immediately before the Proxy client is activated reduces the number of transmissions of the search frame during the proxy search. In contrast, searching in all the DWs allows discovering much more devices although it increases the number of transmissions of a search frame. Alternatively, transmitting a proxy search frame in DW0 in which all the NAN devices may be active can efficiently provide search results. In the present embodiment, for transmission of a search frame, the NAN device 110 transmits a Subscribe message as a proxy of the NAN device 102. For power saving, the Proxy server itself may merely wait for a Publish message from the Publisher without transmitting the Subscribe message.

The NAN device 101 determines whether a Publish message from the Publisher has been received (S407). If Yes, the NAN device 101 determines whether the service indicated by the Publish message matches the service that is searched for by proxy (S408). If the service matches the service that is searched for by proxy, the NAN device 101 filters the search result candidate (S409). For example, if the device to which the Publisher provides the service is indicated by MAC Address or the like and differs from the Proxy client even if the service name matches, the service is not reflected to the search result. If the NAN device 101 has received a plurality of Publish messages from the same NAN device during a certain period, the NAN device 101 outputs one search result candidate. Furthermore, if the radio field intensity at the reception of the Publish message is a fixed value or less, the service can be removed from the search result candidate. The search result candidate is a NAN device or a service that is discovered as a result of the proxy search of the NAN device 101 and includes identification information on the NAN device and information on the service that the discovered NAN device provides. Upon completion of the filtering of the search result, the NAN device 101 calculates the percentage of presence of the search result candidate (S410). For example, suppose that a Subscribe message for a proxy search is transmitted ten times after the preceding calculation of the percentage of presence. If a Publish message is received eight time in response to the ten times of transmission of the Subscribes message, the percentage of presence is 80%. In another calculation method, suppose that five DWs have passed after the preceding calculation of the percentage of presence. If a Publish message is received in three DWs of the five DWs, the percentage of presence is 60%. Another method for calculating the percentage of presence may be used.

Next, the NAN device 101 determines whether the percentage of presence calculated for a certain search result candidate is equal to or higher than a certain threshold. If Yes, the NAN device 101 stores the search result candidate as one of search results (S411). The search result is the details of the search result candidate to be transmitted to the Proxy client and is stored in the storage unit 301 by the NAN device 101. Thus, the filtering and the calculation of the percentage of presence prevent the search result candidate from being excluded from the search result when radio waves do not reach only during the target period and prevent a device that suddenly appears and disappears from being included in the search result. The target periods for the calculation of the percentage of presence may overlap with each other.

Next, the NAN device 101 outputs a Publisher list from the stored search result (S412). The last search result is listed in the Publisher list. The Publisher list is information on the search result that is actually transmitted to the Proxy client. To reduce the amount of data to be transmitted, the preceding Publisher list may be stored, and the difference therefrom may be used as the Publisher list at this time. In this case, at the next S413, it is determined whether there is an NAN device or service to be transmitted. Alternatively, the NAN device 101 may store the result of detection of a search result every time and calculate the average of the past five times as the content of the Publisher list to be transmitted.

Next, the NAN device 101 compares the Publish list to be transmitted this time and the preceding Publisher list to determine whether there is a change (S413). The change in Publisher list is a change in at least the number of NAN devices, identification information, and the details of the service to be provided included in the Publisher list. If there is a change in the Publisher list, the Publisher list stored in the storage unit 301 is updated (S414). Next, the NAN device 101 waits until DW in which the Proxy client is activated (S415) and transmits the Publisher list to the Proxy client (S416).

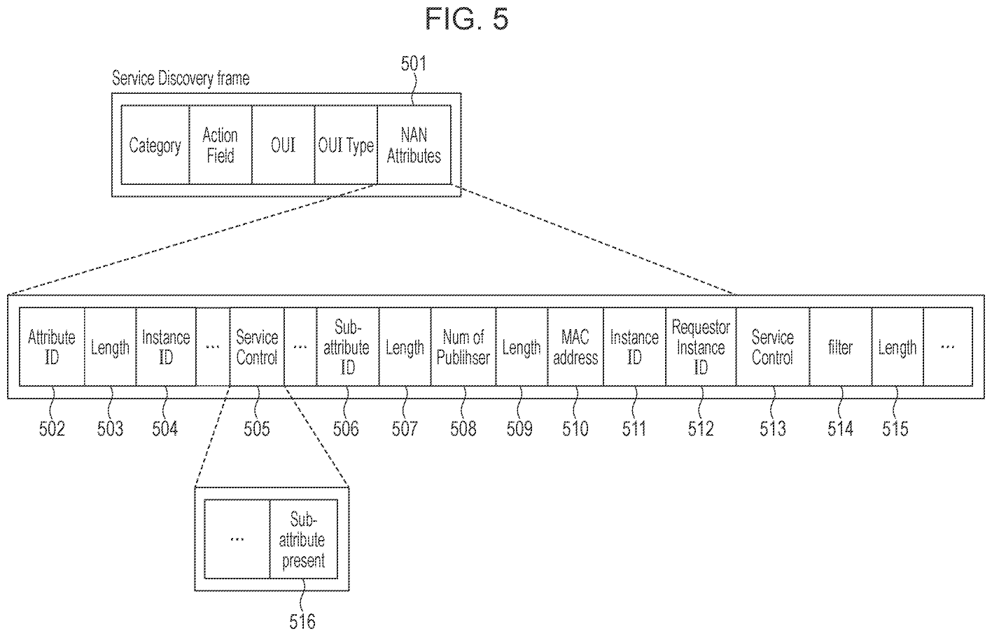

FIG. 5 illustrates an example frame configuration of the Publisher list, which is a Service Discovery frame (SDF), transmitted at that time. The SDF is a public action frame based on the IEEE802.11 standard. The SDF, or the public action frame, includes NAN Attributes 501 indicating information defined by the NAN. The plurality of attributes include a service descriptor attribute. Another attribute may be used, or a combination of attributes may be used.

For example, FIG. 5 illustrates a form in which the service descriptor attribute is partly changed. That is, a service control field 505 of the service descriptor attribute is given a sub-attribute. To indicate the sub-attribute, the 7th-bit, which is not used at present, is used (516). Thus, the service descriptor attribute is given the sub-attribute (506 to 515). The part 506 describes identification data (ID), for example, 0 x 05, indicating that the sub-attribute is a Publisher list (506). Next, the length of the sub-attribute is described (507). Next, Num of Publisher (508), which is the number of Publisher messages to be transmitted, is described. If there is no corresponding Publisher, a value of 0 is transmitted to the Proxy client. The following Length (509) describes the length of information on one Publisher. Mac address(510) describes the Mac address of the Publisher. The parts from Instance ID (511) to filter (514) describe information included in the Publish message. From Length (515) to the subsequent parts, information on each Publish message is continued as in 509 to 514. The above frame configuration is given for illustrative purpose only, and any configuration may be used.

In proxy service search, the NAN device 101 waits for reception of a Publish message at S407 and also reception a Proxy-registration end request from the Proxy client (S417). Upon reception of the Proxy-registration end request, the NAN device 101 ends the proxy search for the service of the target Proxy client and notifies the Proxy client of the status of the service registration updated in response to the Proxy-registration end request (S418). The processes S401, S405, S415, and S417 are independent operations. For that reason, the order may be changed, or the processes may be executed in parallel.

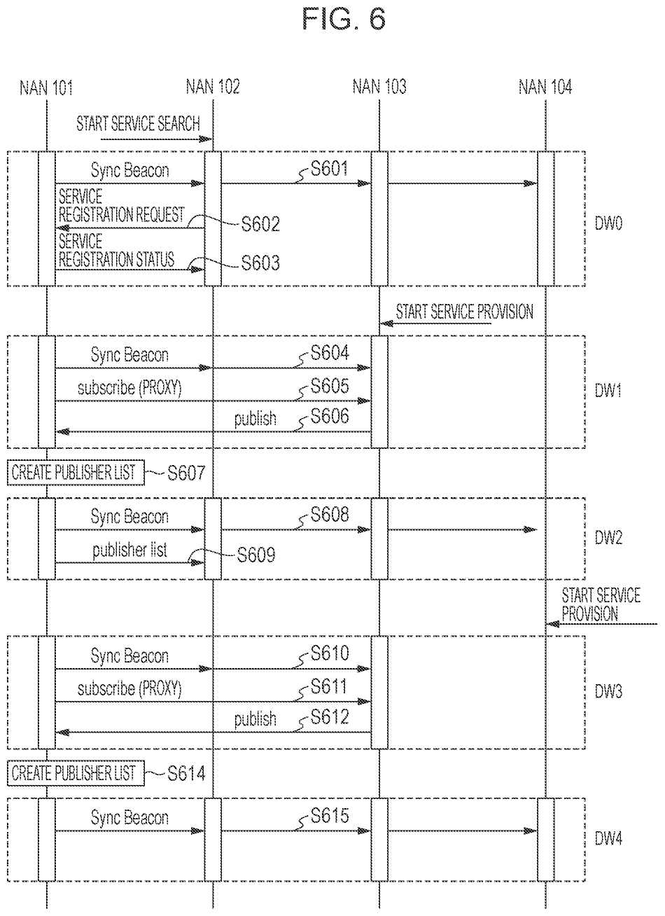

Next, the sequence from when the NAN device 102 acting as Subscriber registers Subscribe to the NAN device 101 to when the NAN device 102 receives a Publisher list will be described with reference to FIG. 6.

In FIG. 6, the NAN device 102 is in the awake (active) mode in DW0, DW2, and DW4 and is in the sleep mode in the other period. The NAN devices 101 and 103 are in the awake mode in all the DWs and are in the sleep mode in the other period. The NAN device 104 is in the awake mode in DW0 and DW4 and is in the sleep mode in the other period. The NAN device 103 transmits a Publish message in DW1 and DW3.

The NAN device 102 starts a service search. In DW0, the NAN device 102 determines that the NAN device 101 acting as Proxy server is present in the neighborhood and transmits a service registration request (S602). Upon receiving the service registration request, the NAN device 101 starts to prepare for a proxy search and transmits a service registration status to the NAN device 102 (S603).

Next, the NAN device 103 starts to provide the service. Upon entering DW1, the NAN device 101 transmits a Subscribe message by proxy (S605), because D1 is DW immediately before the NAN device 102 is activated. Upon receiving the Subscribe message, the NAN device 103 transmits a Publish message (S606). The NAN device 101 creates a Publisher list from the Publish message received in DW1 according to the processing procedure in FIG. 4 (S607). Since the created Publisher list is the first Publisher list transmitted, the NAN device 101 determines to transmit the Publisher list. Upon entering DW2, the NAN device 102 becomes capable of receiving an NAN frame, and then the NAN device 101 transmits the Publisher list (S609).

Next, the NAN device 104 starts to provide the service. Upon entering DW3, the NAN device 101 transmits a Subscribe message by proxy because DW is a DW immediately before the NAN device 102 is activated (S611). Upon receiving the Subscribe message, the NAN device 103 transmits a Publish message (S612). The NAN device 101 creates a Publisher list from the Publish message received in DW3 according to the processing procedure in FIG. 4 (S614). Since the created Publisher list is the same as the Publisher list previously transmitted, the NAN device 101 determines not to transmit the Publisher list. Upon entering DW4, the NAN device 102 becomes capable of receiving an NAN frame, but the NAN device 101 transmits nothing because the NAN device 101 determines not to transmit the Publisher list. Thereafter, if the NAN device 101 can receive the Publish message from the NAN device 104, the NAN device 101 transmits the Publisher list to the NAN device 102 according to the processing procedure in FIG. 4.

Thus, in the present embodiment, the NAN device 101 searches for a service by proxy, and only when the search result has changed, the NAN device 101 transmits a Publisher list to the Proxy client. This reduces the amount of communication for the NAN device 101 to transmit the Publisher list, and thus reducing the power consumption. The device serving as Proxy client may be generally a device that is required to reduce the power consumption as much as possible, such as a smartphone. Since the NAN device 102 serving as Proxy client can receive a Publish list without requesting the Publisher list, the power consumed in transmitting the frame can be reduced. Furthermore, reducing the number of times the Publisher list is received reduces the number of calculations for displaying the search result to the user of the NAN device 102 from the received content, allowing the NAN device 102 to be operated with lower power consumption.

In the processing procedure of FIG. 6, the NAN device 101 transmits a proxy search frame only in DW1 and DW3, which are DWs immediately before the NAN device 102 enters a receivable mode. Alternatively, the NAN device 101 may transmit the proxy search frame in DW0, for example. The NAN device 102 may enter the receivable mode in a cycle and period other than a specific DW after registering the service as Proxy client. For example, the NAN device 102 may enter the receivable mode only for 16 msec at intervals of 2 min. In that case, the NAN device 101 may transmit the proxy search frame only in DW before the Proxy client enters the receivable mode and in DW0. This allows the NAN device 102 to perform the service search with lower power consumption.

### Second Embodiment

In the first embodiment, the NAN device 101 acting as Proxy server transmits a Publisher list to the Proxy client, with a change in the Publisher list as a trigger. In contrast, in the present embodiment, when the service registration status managed by the NAN device 101 acting as Proxy server has changed, the NAN device 101 notifies the Proxy client of the change.

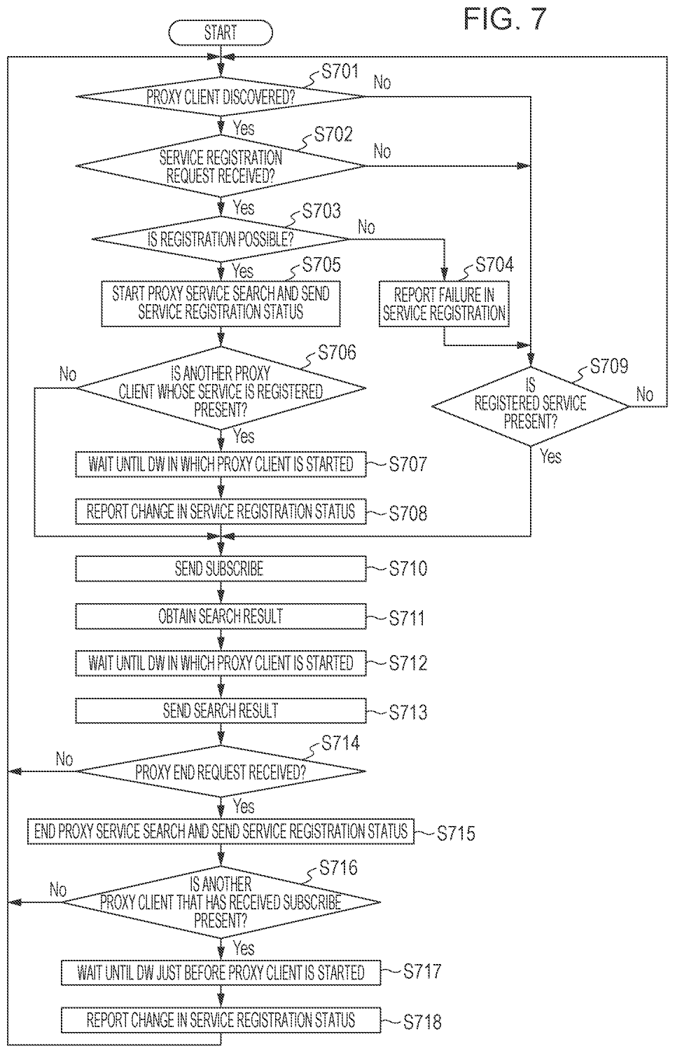

The operation of the NAN device 101 that performs a service search in the NAN cluster 106 as a proxy for the NAN device 102 will be described with reference to the flowchart in FIG. 7. The flowchart is started when the NAN device 101 participates in the NAN cluster 106 and starts the operation as a Proxy server. The flowchart of FIG. 7 is executed by the control unit 302 of the NAN device 101 executing a control program stored in the storage unit 301 to execute computation and processing of information and control of each hardware component. Part or all of the steps of the flowchart in FIG. 7 may be implemented by hardware, such as an ASIC.

Upon starting the operation as a Proxy server, the NAN device 101 notifies the neighboring devices that the NAN device 101 can act as Proxy server. The NAN device 101 determines whether a Proxy client has been discovered (S701). If a Proxy client has been discovered, the NAN device 101 determines whether a proxy service search request has been received from the Proxy client (S702). If a proxy search request has been received, the NAN device 101 determines whether service registration is possible (S703). If the determination result shows that service registration is impossible, the NAN device 101 transmits a notification of the failure in service registration to the Proxy client (S704). If service registration is possible, the NAN device 101 registers the details of the request as service registration and starts a service proxy search (S705). Furthermore, the NAN device 101 transmits a service registration status to the Proxy client requesting the proxy search (S705).

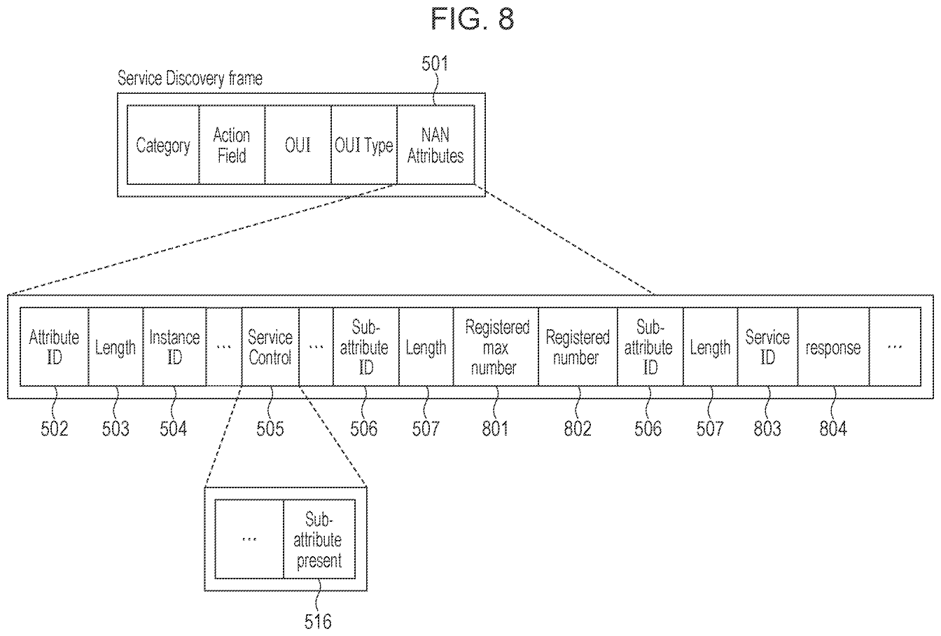

FIG. 8 illustrates an example frame configuration of service registration, which is a Service Discovery frame (SDF) transmitted at that time. The SDF is a public action frame based on the IEEE802.11 standard. The SDF, or the public action frame, includes NAN Attributes 501 indicating information defined by the NAN. Since part of the frame configuration (501 to 507 and 516) is the same as that of the first embodiment, descriptions thereof will be omitted. Part 506 describes ID indicating that sub-attribute is a service registration status. In this case, the ID is 0 x 07. Parts 801 and 802 show the maximum number of services that can be registered in the NAN device 101 and the number of services registered at the present, respectively.

At S705 in which the details of the request are registered as service registration, the second sub-attribute is given. The second sub-attribute describes, for example, 0 x 01, in 506. An ID indicating a service corresponding to the response is described in 803. Furthermore, a value used for determining whether the request for registration of the target service has succeeded is described in 804.

The above frame configuration is given for illustrative purpose only, and any configuration may be used. For example, 801 and 802 may be describes for each of Publish and Subscribe. This allows, when the number of registerable services differ between Publish and Subscribe, to give a notification thereof. The sub-attributes may be combined to one. If “response refused” is input to 804, a region indicating the reason may be provided. The sub-attributes may be divided for each frame and may be transmitted twice. This allows, for example, transmitting the frame in FIG. 8 to the transmitter of the registration request and transmitting only the first sub-attribute to another Proxy client or neighboring NAN devices.

In registering a new service, the information of the first sub-attribute may not be transmitted, and only when the number of registered services decreases, a notification thereof may be transmitted. This allows the Proxy client that has abandoned a new service registration request for the reason that the number of services registered in the Proxy server has reached the upper limit to determine the time to register the new service.

The sub-attributes may be transmitted all at once with Multicast or Broadcast. This allows the proxy service registration status of the Proxy server to be reported to the neighboring devices. In preparation for a case in which services are registered from a plurality of Proxy clients, and a specific Proxy client is not in a receivable mode, the following processing is performed. First, the NAN device 101 determines whether a Proxy client that registers a service by proxy is present in addition to the Proxy client that has reported the service registration status (S706). If an applicable Proxy client is present, the NAN device 101 waits until DW in which the Proxy client becomes ready for reception (S707). If the Proxy client becomes ready for reception in a period other than DW, the NAN device 101 may wait until the period. When the applicable Proxy client becomes ready for reception, the NAN device 101 notifies the Proxy client of the service registration status (S708).

In this case, the NAN device 101 may register the plurality of services of a plurality of Proxy clients. For that reason, if a registered service is present even if the NAN device 101 cannot receive a service registration request at a certain timing, the NAN device 101 proceeds to S710 (S709), and starts a proxy search as Proxy server. Since the operation of the NAN device 101 when the proxy search is started (S710 to S713) is the same as the operation in the first embodiment, a description thereof will be omitted.

In the proxy service search, the NAN device 101 waits for reception of a Publish message at 5711 and also reception of a Proxy-registration end request from the Proxy client (S714). Upon reception of the Proxy-registration end request, the NAN device 101 ends the proxy search for the service of the target Proxy client and notifies the Proxy client of the status of the service registration updated in response to the Proxy-registration end request (S715). The service registration status is reported in the same way as that from S705 to S708 (S715 to S718). The operations of S701, S710, and S714 are independent of one another, as in the first embodiment. The order of the operations may be changed, or the operations may be executed in parallel.

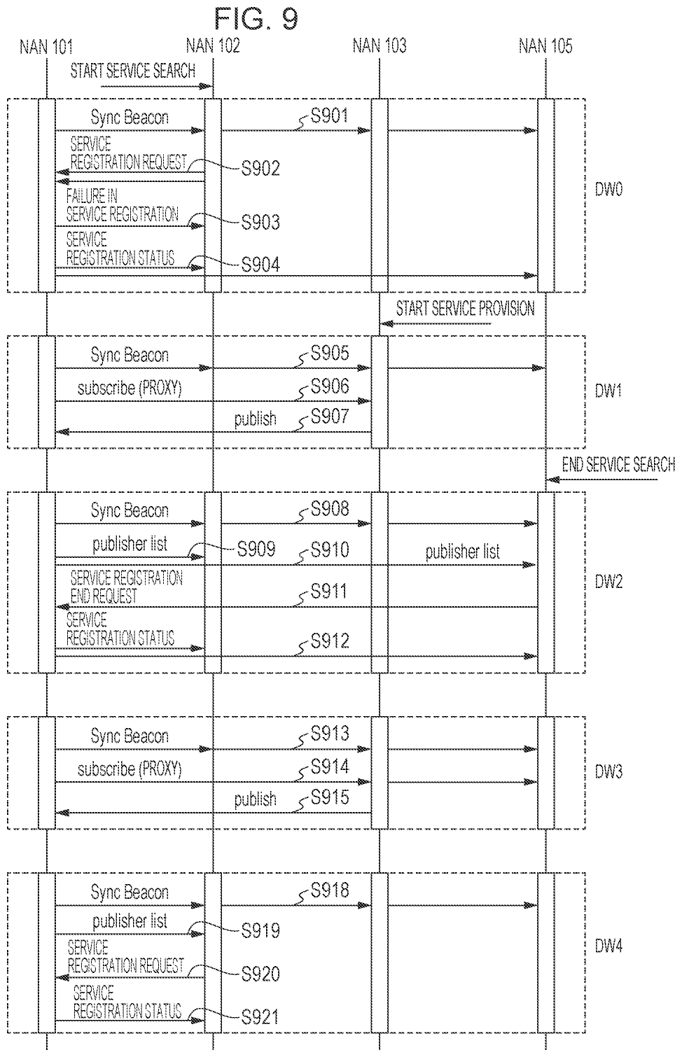

Next, a sequence until the NAN device 102 acting as Subscriber registers two services in the NAN device 101 will be described with reference to FIG. 9.

In FIG. 9, the NAN device 102 is in the awake (active) mode in DW0, DW2, and DW4 and is in the sleep mode in the other period. The NAN devices 101 and 103 are in the awake mode in all the DWs and are in the sleep mode in the period other than DWs. The NAN device 105 is in the awake mode in DW0, DW2, DW3, and DW4 and is in the sleep mode in the other period. The NAN device 103 transmits a Publish message in DW1 and DW3. At the start of this sequence, the NAN device 101 acts as Proxy server, and the NAN device 105 issues a photo-sharing service proxy search. The NAN device 105 starts service search end processing between DW1 and DW2. The NAN device 101 can search for five services in total by proxy and has already been searching for four services including the photo-sharing service that the NAN device 105 requests by proxy.

The NAN device 102 starts a service search. Upon entering DW0, the NAN device 102 determines that the NAN device 101 acting as Proxy server is present in the neighborhood. Next, the NAN device 102 transmits a service registration request for each of a print service and a chat service that the NAN device 102 wants to request for a proxy search (S902). The service registration requests may be performed all together. The service registrations may be requested in order of preference. Upon receiving the service registration requests, the NAN device 101 determines whether the services can be registered and, if possible, starts preparation for the proxy search and transmits the service registration status to the NAN device 102 (S903). In the present embodiment, the number of services that the NAN device 101 can newly register is one. Therefore, the NAN device 101 registers only the print service in the proxy search and sends a registration disable response for the chat service. Since the print service is added as a new proxy search item, the NAN device 101 transmits the service registration status to each Proxy client (S904). In DW1, the NAN device 101 searches for the service as a proxy of the NAN devices 102 and 105 (S906).

Next, the NAN device 105 ends the search for the photo-sharing service. Upon entering DW2, the NAN devices 102 and 105 become ready for receiving an NAN frame, and therefore the NAN device 101 transmits Publisher lists (S909 and S910).

Since the NAN device 105 has received a service search end notification from the user, the NAN device 105 transmits a request for ending the service registration (S911). Upon receiving the service registration end request from the NAN device 105, the NAN device 101 ends the proxy search for the photo-sharing service and transmits the service registration status to each Proxy client (S912). Here, the NAN device 102 finds that the capacity of a proxy search request to the NAN device 101 has increased.

Therefore, the NAN device 102 transmits a service registration request to the NAN device 101 in DW4 in which the NAN device 102 enters the awake mode (S920). The NAN device 101 determines that the service can be registered, starts a proxy search, and transmits the service registration status to the NAN device 102 (S921).

Thus, since the Proxy server transmits the service registration status to the other NAN devices at an appropriate timing, the Proxy clients can determine an appropriate timing for requesting a proxy service search. Furthermore, the Proxy clients can always grasp the availability of registration of a service to the Proxy server since the Proxy server transmits the service registration status also when a new service is registered. Thus, when receiving a new service search instruction from the user, the Proxy clients can singly determine whether a proxy search can be requested from the Proxy server.

### Other Embodiments

In the above embodiments, the NAN device 102 is in the awake mode in DW0, DW2, and DW4 but may be in the awake mode in other DWs. In the above embodiments, the NAN device 101 acts as Proxy server in searching for a service that the NAN device 102 requests. However, what is transmitted using the Proxy function is not limited to the information on the service that is searched for. For example, the NAN device 101 may receive a notification of a service provided by another device and reports the service in place of the device. In this case, the NAN device 101 can search for the service by transmitting a Publish message of the other device by proxy an receiving a Subscribe message or a Follow-up message responding thereto. The NAN device 101 may wait for a Subscribe message that another device spontaneously has transmitted without transmitting a Publish message. In any case, the NAN device 101 can provide a notification of the search result to a device that requests a proxy service search in a DW period in which the device can receive a radio signal.

The number of proxy services that can be registered in the Proxy server can be set at any value in the above embodiments. The number of Proxy services may be dynamically changed depending on the load status of the Proxy server. In the above embodiments, the service registration status is expressed as the number of proxy services, but may be expressed in another way. For example, a list of IDs of registered services may be transmitted. This allows a Proxy client to determine in advance whether a new proxy service search can be executed in cooperation with another Proxy client.

In the above embodiments, a notification is provided to the Proxy client every time a stored search result or registered service has changed. The notifications may be transmitted all at once when the search result or the registered service has been changed several times. For example, in the case where there is a difference between the first search result and the second search result, and there is also a difference between the second search result and the third search result, only the third search result may be transmitted. This allows further reducing the frames to be transmitted to the Proxy client. In this case, for example, when only the difference is transmitted, the difference between the first search result and the second search result and the difference between the second search result and the third search result may be transmitted all at once. In the above embodiments, the NAN device 101 receives a Proxy request from the NAN device 102. Alternatively, the NAN device 101 may receive a Proxy request from other one or more NAN devices.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A communication apparatus comprising:
a communication unit configured to transmit and receive a radio signal in a period of a predetermined length that comes at predetermined time intervals;
a processing unit configured to perform a proxy process of at least transmission and reception of the radio signal in the period as a proxy of a specific communication apparatus belonging to a group of a plurality of communication apparatuses synchronizing in the period;
a storage unit configured to store at least one of a result of the proxy process performed by the processing unit, the proxy process to be performed by the processing unit, and a number of operations of the proxy process;
a determination unit configured to determine whether details stored by the storage unit have changed; and
a notification unit configured, when the determination unit determines that the details have changed, to provide a notification based on the details stored in the storage unit to the specific communication apparatus.

2. The communication apparatus according to claim 1, wherein the notification unit provides the notification to the specific communication apparatus in the period.

3. The communication apparatus according to claim 1, wherein, when the specific communication apparatus is active in part of a plurality of the periods and is inactive in remaining part of the periods, the processing unit performs the proxy process in the period immediately before the period in which the specific communication apparatus is active.

4. The communication apparatus according to claim 1, wherein the proxy process performed by the processing unit is a process for searching for an apparatus that provides a service.

5. The communication apparatus according to claim 1, wherein the proxy process stored by the storage unit includes information indicating a service to be searched for.

6. The communication apparatus according to claim 1, wherein the number of proxy processes stored by the storage unit corresponds to a number of specific communication apparatuses that request the proxy process.

7. The communication apparatus according to claim 1, wherein the storage unit stores at least one of the result of the proxy process performed by the processing unit, the proxy process to be performed by the processing unit, and the number of operations of the proxy process, and identification information on the specific communication apparatus that requests the proxy process.

8. The communication apparatus according to claim 1, wherein the radio signal includes a signal indicating a service that another communication apparatus provides.

9. The communication apparatus according to claim 1, wherein the radio signal includes a signal for searching for a service that another communication apparatus provides.

10. The communication apparatus according to claim 1,
wherein the period is Discovery Window defined by a Wi-Fi neighbor awareness networking standard, and
wherein the group of the plurality of communication apparatuses is a NAN cluster defined by the Wi-Fi neighbor awareness networking standard.

11. The communication apparatus according to claim 1, wherein the notification unit provides the notification using a Service Discovery frame defined by the Wi-Fi neighbor awareness networking standard.

12. A method for communication comprising:
a transmitting step of transmitting and receiving a radio signal in a period of a predetermined length that comes at predetermined time intervals;
a processing step of performing a proxy process of at least transmission and reception of the radio signal in the period as a proxy of a specific communication apparatus belonging to a group of a plurality of communication apparatuses synchronizing in the period;
a storing step of storing at least one of a result of the proxy process performed in the processing step, the proxy process to be performed in the processing step, and a number of operations of the proxy process;
a determination step of determining whether details stored in the storing step have changed; and
a notification step of, when it is determined in the determination step that the details have changed, providing a notification based on the details stored in the storing step to the specific communication apparatus

13. A non-transitory computer-readable storage medium storing a computer program for causing a computer to function as:
a communication unit configured to transmit and receive a radio signal in a period of a predetermined length that comes at predetermined time intervals;
a processing unit configured to perform a proxy process of at least transmission and reception of the radio signal in the period as a proxy of a specific communication apparatus belonging to a group of a plurality of communication apparatuses synchronizing in the period;
a storage unit configured to store at least one of a result of the proxy process performed by the processing unit, the proxy process to be performed by the processing unit, and a number of operations of the proxy process;
a determination unit configured to determine whether details stored by the storage unit have changed; and
a notification unit configured, when the determination unit determines that the details have changed, to provide a notification based on the details stored in the storage unit to the specific communication apparatus.
